(19) United States
(12) Patent Application Publication
(10) Pub. No.: US 2020/0387909 A1
(43) Pub. Date: Dec. 10, 2020

(54) SYSTEMS AND METHODS FOR REAL TIME DETECTION AND RESOLUTION OF SERVICE NEEDS OF AN ENTERPRISE

(71) Applicant: STUPA IT SERVICES PVT. LTD., Chennai (IN)

(72) Inventors: Subrata Kumar MANDAL, Bangalore (IN); Surajit BOSE, Chennai (IN)

(73) Assignee: STUPA IT SERVICES PVT. LTD., Chennai (IN)

(21) Appl. No.: 16/763,174

(22) PCT Filed: May 23, 2018
(86) PCT No.: PCT/IN2018/050326

§ 371 Date: May 11, 2020

(30) Foreign Application Priority Data
Jan. 25, 2018 (IN) 201841002996

(51) Int. Cl. G06Q 30/00; G06Q 10/00

(52) U.S. Cl. CPC G06Q 30/016; G06Q 10/20

(57) ABSTRACT

In an example, a system for resolution of service needs of an enterprise is disclosed. At least one service need associated with an entity of the enterprise is derived from a service related data fetched from the entity. An error type associated with the at least one service need is retrieved from a digital research expert based on one or more predefined technology area, application area and device category as identified with the at least one service need. A resolution to the error type is requested from a solution bot. Further, in case the solution bot fails to provide a satisfactory resolution, the at least one service need may be assigned to a specific resolver group capable of resolving the at least one service need as pre predefined service resolution agreements.

### FIELD OF THE INVENTION

This invention relates generally to data processing. More particularly, this invention relates to artificial intelligence systems deployed to process service needs of an enterprise.

### BACKGROUND OF THE INVENTION

In a typical enterprise architecture framework involving organizational layers of consumer applications, business applications, devices, machines and people working in unison, various service needs such as problems, incidents, tasks, and service requests transpire on a regular basis. Such service needs necessitate attention and periodic resolution to enable smooth functioning of the enterprise framework.

Some enterprise architectures deploy customer service representatives (CSR) or technician desks that include specialized personnel capable of resolving various service needs of the enterprise. However, such technician desks typically require manual inputs that indicate a type, and severity and provide details of the service needs prior to initiating resolution of the service needs. Depending on such manual inputs may delay and in some instances thwart the process of resolution when the service needs are detected beyond a stipulated time frame or are left unidentified. Further, dependence on such technician desks tend to increase a cost and high lead time of resolution within such enterprises especially when the service needs are of repetitive nature. In such cases, several specialized persons may be required for resolving each instance of a repetitive service need.

Hence there is a need for an enterprise solution that reduces dependence on manual inputs for detecting the service needs of an enterprise. The enterprise solution should provide an automated system for detection and resolution of service needs. As a result, an automated system and method for effecting real-time detection and resolution of service needs of the enterprise is proposed.

### BRIEF DESCRIPTION OF THE DRAWINGS

Examples are described in the following detailed description and in reference to the drawings, in which:

FIG. 1 is a block diagram of an environment including a system for providing real-time detection and resolution of service needs of an enterprise, in accordance with an example embodiment;

FIG. 2A-2B depicts a flowchart illustrating a method to resolve at least one service need of an enterprise, in accordance with an example embodiment; and

FIG. 3 depict example block diagrams showing a non-transitory computer-readable media representing a big data bin of FIG. 1, that derives at least one service need associated with an entity of an enterprise, in accordance with an example embodiment;

FIG. 4A-4B depict example block diagrams showing a non-transitory computer-readable media representing an automated digital service desk of FIG. 1, that provides real-time resolution of service needs of an enterprise, in accordance with an example embodiment; and

FIG. 5 depict example block diagrams showing a non-transitory computer-readable media representing a digital research expert of FIG. 1, to facilitate provisioning of real-time resolution of service needs of an enterprise, in accordance with an example embodiment.

### DETAILED DESCRIPTION

In an enterprise environment, such as a production environment in an automotive sector, several service needs may arise pertaining to maintenance of machines involved in the production, procurement of materials required, identification of anomalies in the line of production, safety measures, and the like.

An example of a service need pertaining to maintenance of lathe machines involved in production of metallic fixtures of automobiles may include switching off the lathe machines for a predefined time interval post a continuous time-period of operation, and facilitating servicing and ancillary operations before using the lathe machines for a subsequent production. Typically, human personnel may be deployed for surveillance of the lathe machines, and identifying the time for switching off the lathe machines for maintenance purposes. Dependence on such human personnel may result in human-related errors, and extra cost on the enterprise. Automatic detection and resolution of such service needs of an enterprise may overcome aforementioned human-related errors, and reduce the cost involved in running the enterprise, increase productive time and reduce failure time.

Examples described herein provide a system that may identify a service need of the enterprise automatically by procuring and processing a plurality of service related data associated with the service need. Service related data pertaining to a plurality of entities such as consumer applications, business applications, machines, devices and people of the enterprise can be collected using a plurality of adaptors. Applying predefined enterprise rules on the procured service related data enables the system to identify the service need of the enterprise. The identified service need is then provided to an automated digital service desk. Built using artificial intelligence routines that automate provision of resolutions to service needs of an enterprise. The resolutions to service needs may be provisioned by a solution bot, an artificial intelligence based module, automatically when the resolutions are readily available in a data repository.

Further, service needs that are unresolved by the solution bot, can be routed by the automated digital service desk to one or more specific resolver groups chosen from a plurality of resolver groups associated with the enterprise. The specific resolver group may typically include a human agent specialized in resolving a particular type of service need, whereas the plurality of resolver groups may include an entire manpower of the enterprise dedicated to resolving the plurality of service needs that transpire in the enterprise. The automated service desk may be designed to identify a specific resolver group capable of resolving a particular service need.

Examples described herein, incorporate updated industry best practices for resolution of the service needs, thereby providing an enriched user experience. Further, a single platform may incorporate resolution of service needs transpiring from a plurality of entities of the enterprise such as devices, machines, consumer and business applications, and human personnel. Use of solution bots and automated resolution improves business productivity and reduces a latency time involved during service resolution. Further, lesser human dependency of the system results in a relatively economical and error-free process of service need resolution of the enterprise.

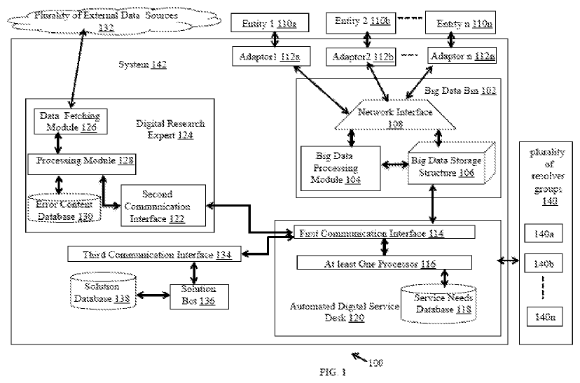

FIG. 1 depicts an environment 100 including a system 142 for providing realtime resolution of service needs of an enterprise. In an example, the environment 100 may include a service location or a production department of an enterprise where a plurality of service needs transpire for resolution. In the example embodiment, the enterprise may include an automobile company involved in manufacturing automobile engines. In another example, the environment 100 may include an Information Technology Services industry that provides software services. As shown, the environment 100 includes a plurality of entities 110a-n, the system 142, a plurality of external data sources 132 and a plurality of resolver groups 140a-n. The plurality of entities 110a-n may include human personnel, consumer applications, business applications, machines or devices functioning and executing processes within the enterprise.

The system 142 includes a plurality of adaptors 112a-n, a big data bin 102, an automated service desk 120, a solution bot 136, a solution database 138, and a digital research expert 124. The plurality of adaptors 112a-n interface with the plurality of entities 110a-n to capture a plurality of service related data pertaining to the plurality of service needs of the enterprise. The plurality of adaptors 112a-n can further communicate the service related data to the big data bin 102.

For example, an adaptor 112a may include a plurality of sensors coupled to a machine, such as a ceiling fan, and an Internet of Things (TOT) device. The service related data of the ceiling fan can be captured by the plurality of sensors and the service related data can be transmitted by the IOT device to the big data bin 102. In another example, a set of proprietary adaptors may be deployed within a plurality of machines to transmit service related data to the big data bin 102 in a regulated manner. In another example, another set of proprietary adaptors may communicate a plurality of service related data pertaining to the consumer applications and the business applications to the big data bin 102.

The big data bin 102 may include a network interface 108, a big data processing module 104, and a big data storage structure 106. The network interface 108 is operable to communicate with the plurality of adaptors 112a-n for purpose of receiving the plurality of service related data. The big data processing module 104 may receive the plurality of service related data from the network interface 108. The plurality of service related data may be received in a structured, semi-structured or unstructured format. The big data storage structure 106 stores the received plurality of service related data in the structured, semi-structured or unstructured format. Further, the data processing module 104 may receive a service related data associated with an entity from the big data storage structure 106 and harmonize the service related data into a plurality of meaningful data units based on at least one of entity specific rules, entity related properties, enterprise related policies, and enterprise related procedures. Furthermore, the data processing module 104 may derive at least one service need associated with the entity from the plurality of meaningful data units based on predefined enterprise rules.

For example, if the entity is a consumer application designed to monitor a web traffic of a website associated with the enterprise, then a proprietary adaptor coupled with the consumer application may retrieve a service related data such as contact details, personal details, geographical location, preferences, and the like of the users that visit the website for a predefined time interval. The service related data may be captured in a plurality of formats. For instance, the service related data may be in a structured, unstructured or semi-structured format. Further, the big data processing module 104 may harmonize the service related data into smaller or meaningful data units such as age, name, gender, country, state, pin code, likes, dislikes, time preferences and such other indivisible data units using predefined rules, and properties of the consumer application, and using policies and procedures as defined by the enterprise. Further, a predefined enterprise rule may include creation of a notification alert and procuring customer service personnel to communicate with users that browse the website for greater than the predefined time interval, with an intention of boosting sales of services advertised on the website. In such a case, the big data processing module 104, may apply the enterprise rule on the harmonized service related data to derive the at least one service need of procuring the customer service personnel for communicating with aforesaid users.

Further, the automated digital service desk 120 may enable resolution of the at least one service need as described herein. The automated digital service desk 120 may include a first communication interface 114, at least one processor 116, and a service need database 118. The first communication interface 114, may receive the at least one service need from the bigdata processing module 104. In an example the first communication interface 114 may include a wireless interface such as Bluetooth® to communicate with the big data bin 102. In an example embodiment, the first communication interface 114 may include a chat bot configured to communicate directly with a human entity to receive a service request and identify the at least one service need from the service request.

Further, the first communication interface 114 may send a request for industry standard data related to the at least one service need to the digital research expert 124. The industry standard data may include latest industry practices followed, in respect to the at least one service need. The digital research expert 124 may include a second communication interface 122, a data fetching module 126, a processing module 128 and an error content database 130. The second communication interface 122 may include a wireless communication protocol and interfaces or wired interfaces used for communicating with the first communication interface 114 of the automated service desk 120, and a third communication interface 134 associated with the solution bot 136. The data fetching module 126 may include web crawlers or data fetching bots that can scan and capture web data related to new evolving industry best practices. In practice, the data fetching module 126 may retrieve an updated set of industry standard data comprising industry trend data and error type related to one or more of technology areas, application areas and device categories related to the plurality of entities 110a-n from a plurality of external data sources. The external data sources may include proprietary databases, the Internet, private and public cloud data sources and the like. The processing module 128 may analyze and validate the retrieved set of industry standard data. Further, the processing module 128 may identify the error type associated with the one or more of the technology areas, the application areas and the device categories.

The processing module 128 may include an artificial intelligence based engine programmed to follow preset rules to analyze and validate the set of industry standard data. The validated set of industry standard data is then stored in the error content database 130. For example, a new industry best practice identified from the industry standard data is automatically validated and populated in the error content database 130 by the processing module 128. Further, the error content database 130 stores a set of predefined external rules, where a predefined external rule comprises one or more service needs mapped to one or more validated industry standard data. As a result, referring to the error content database 130 including updated set of industry best practices enables an accurate detection of service needs. Aforesaid automatic validation and population of the error content database 130 reduces dependence on expert human intervention for retrieving industry best practices associated with the service need.

Further, the error content database 130 may store the industry standard data in a structured format including technology areas, application areas, and device categories associated with the at least one service need. Further, upon receiving a request for the industry standard data related to the at least one service need from the first communication interface 114 of the automated digital service desk 120, the second communication interface 122 may provide the automated digital service desk 120 with one or more predefined external rules, and error type data related to the at least one service need as stored in the error content database 130.

Upon receiving the error type associated with the at least one service need, the at least one processor 116 may request, via the first communication interface 114 and the third communication interface 134, the solution bot 136 for a resolution to the error type associated with at least one service need. In an example, the solution bot 136 may include a typical artificial intelligence (AI) based processor configured to execute AI based instructions stored in a memory coupled to the processor. Further, the solution bot 136 may scan through the solution database 138 for a resolution to the at least one service need. The solution database 138 is typically a repository containing resolutions provided to prior raised one or more service needs of the enterprise. In case the solution bot 136 succeeds in retrieving a satisfactory resolution to the at least one service need from the solution database 138, the solution bot 136 may enable provisioning of the resolution to the entity associated with the at least one service need. In case the solution bot 136 fails to retrieve a satisfactory resolution to the at least one service need from the solution database 138, the at least one processor 116 may identify a specific service provider organization and specific resolver group viz. resolver group 140b from the plurality of resolver groups 140 existing within the specific service provider organization, that is capable of resolving the at least one service need. Further, the at least one processor 116 may assign the at least one service need to the specific resolver group 140b for enabling resolution of the at least one service need by the specific resolver group 140b as per predefined service resolution agreements. The resolution provided by the special resolver group 140b can be provided to the entity by displaying the resolution on a user interface device such as a Liquid Crystal Display (LCD), monitor, Light Emitting Diode (LED) display microphone, speaker, or any other audio-visual device. Further, the at least one processor 116 may update the solution bot 136 and the solution database 138 with the resolution provided by the specific resolver group 140b.

In an example embodiment, the at least one service need may be at least one of an incident, a problem, a service request and a change request. In the example, the at least one processor 116 of the automated service desk 120 may identify the at least one service need as the incident when the plurality of meaningful data units map to a first pattern that indicates existence of an abnormality in reference to an expected key performance indicator of the entity. For example, in case the entity 110a is a machine designed by a manufacturer to operate within 100 degree Celsius as illustrated further in one of the enterprise predefined rules. However, if the adaptor 112a records a temperature of 150 degree Celsius of the machine 110a for period of five days, and provides aforesaid service related data of the machine to the automated digital service desk 120. The at least one processor 116 may identify the at least one service need as an incident with respect to the machine, due to existence of abnormal working temperatures of the machine viz. 150 degree Celsius in reference to 100 degree Celsius which is mentioned as the key performance temperature of the machine in the predefined rules.

Further, the at least one processor may identify the at least one service need as the problem when the plurality of meaningful data units map to a second pattern that indicates a probability of occurrence of an abnormality in reference to the expected key performance indicator of the entity. For example, if the operating temperature of the machine 110a in the aforesaid example, was recorded by the adaptor 112a to be 120 degree Celsius over the period of 5 days, and the industry standard data as retrieved from the digital research expert 124 reveals a safe operating temperature of the machine to be 125 degree Celsius, then even though the predefined enterprise rule mentions a safe operating temperature of 100 degree Celsius, the automated digital service desk 120 may identify the at least one service need as the problem, as the operating temperature is within a threshold value defined as per the industry standard data, which indicates a probability of occurrence of an abnormality. By operating the machine 110a at 120 degree Celsius for an extended duration, the temperature of the machine may rise subsequently and may exceed the preset threshold provided in the industry standard data. Hence the at least service need may be identified as the problem requiring maintenance staff to observe and monitor the operating temperature of the machine 110a for a stipulated time frame, and perform necessary action to avoid occurrence of an incident.

Further, the at least one service need may be identified by the at least one processor 116, as the service request when the plurality of meaningful data units map to a third pattern that indicates one of provisioning of resources and execution of additional tasks essential for meeting at least one requirement of the entity. For example, if the predefined enterprise rule includes a shut-down period of five days for the machine 110a that has been in operation for a continuous period of 30 days, and the at least one processor 116 may identify the at least one service need as a service request requiring maintenance personnel to perform maintenance and other ancillary functions for next five days when the service related data as provided by the adaptor 112a indicates that the machine 110 has been in continuous operation for 30 days. The at least one processor 116 may further route the service request to a specific resolver group of the plurality of resolver groups 140 that looks into maintenance operations of the machine 110a.

Furthermore, the at least one processor 116 may identify the at least one service need as the change request when the plurality of meaningful data units map to a fourth pattern that indicates enhancing the expected performance behavior of the entity to meet at least one additional enterprise requirements. For example, in an enterprise dealing with provisioning of online web services and software products, may have an official website catering to customers. A predefined enterprise rule may state that the official website must enable visitors to download catalogues and other product relate information within a stipulated time period of two minutes. However, if an IOT adaptor coupled to the website records a download time exceeding two minutes experienced by one or more visitors, the at least one processor 116 may identify the at least one service need associated with the official website as a change request, as an enhancement in the performance of the official website is required. As a result, the at least one processor 116 may identify the change request effecting a change or upgrade of web servers and web processors involved in running the official website so that the download of catalogues is achieved within the stipulated time period as mentioned by the predefined enterprise rule.

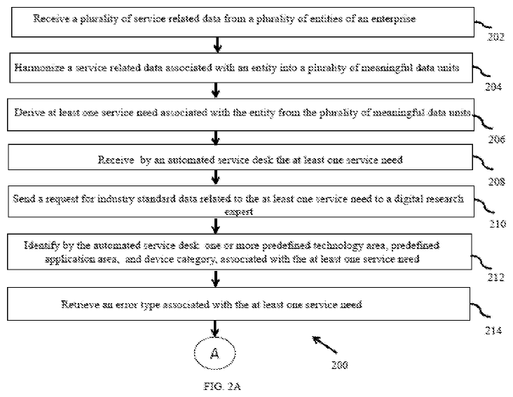

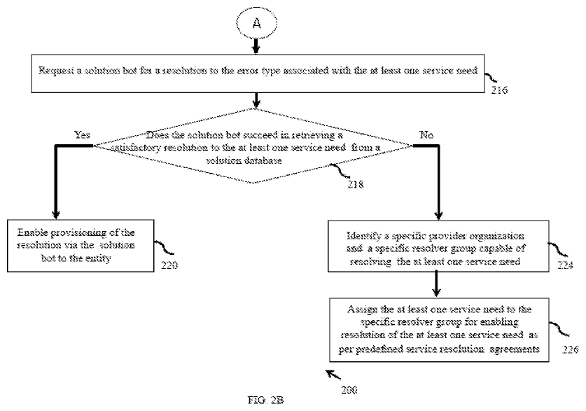

FIG. 2A-2B is a flowchart illustrating a method 200 for resolving at least one service needs of the enterprise. At 202, a plurality of service related data is received by a big data processing module, from a network interface coupled to a plurality of entities of the enterprise. A plurality of adaptors may fetch the service related data from the plurality of entities where each adaptor may be coupled to one entity of the enterprise. For example, an enterprise may include a service environment that provides Information technology services, a manufacturing and monitoring unit of a production company, an online retail store and the like.

Further, the plurality of entities may include people, machines, devices, consumer applications and business applications as applicable to the entity. Further, the plurality of adaptors may communicate the plurality of service related data to the network interface coupled to a bigdata processing module. Further, the plurality of service related data maybe stored in a big data storage structure is communicatively coupled to the network interface, one of a structured, unstructured, and semi-structured format.

At 204, a service related data associated with an entity may be harmonized by the bigdata processing module into a plurality of meaningful data units based on at least one of entity specific rules, entity related properties, enterprise related policies, and enterprise related procedures.

At 206, at least one service need associated with the entity, may be derived by the big data processing module, from the plurality of meaningful data units based on predefined enterprise rules. Typically, when a meaningful data unit is statistically correlated with predefined enterprise rules or entity related properties, certain patterns of unexpected behavior of the entity can be observed. Such patterns of unexpected behavior from the entity typically indicate arrival of one or more service needs associated with the entity. For example, when a visitor accessing a website hosted by an enterprise seeks to download a product catalog, is met with a website latency time of two minutes, a plurality of meaningful data units pertaining to the visitor may be obtained. The plurality of meaningful data units may include, a geographical location of the visitor, a latency time observed by the visitor viz. two minutes in aforesaid example, a plurality of personal preferences of the visitor, a time and date of download, and the like. Further, a predefined enterprise rule may define an expected latency time of one minute for downloading the product catalog. The observed latency time may be correlated with the expected latency time as defined in the enterprise rule, to identify a service need associated with the website performance at the geographical location.

In another scenario, where employees of an enterprise are involved in making sales order, the plurality of meaningful data units obtained would include an employee details of an employee creating a sales order, a type of sales order, a date of creation of the sales order, and a time taken for creating the sales order. In case, a predefined enterprise rule specifies a particular day of the week for creation of sales orders, and a maximum time required for creation of the sales order, the time taken by the employee and the date of creation of the sales order as obtained from the meaningful data units may be correlated with the predefined enterprise rule, to identify a service need. In case, an employee of the enterprise attempts to create a sales order on weekday other than that specified in the rule, and takes more than the maximum time required for creating a particular sales order, a problem related service need may be identified.

At 208, the at least one service need may be received by an automated digital service desk from the bigdata processing module. The automated digital service desk may include at least one processor and a memory including artificial intelligence routines which when executed facilitate resolution of the at least one service need.

At 210, a request for industry standard data related to the at least one service need may be communicated from the automated digital service desk using a first communication interface to a digital research expert. The at least one service need may be received via a second communication interface by the digital research expert. The digital research expert may include processing module including a plurality of artificial intelligence routines which when executed, retrieve a plurality of a resolutions to a plurality of service needs. For example, the digital research expert may include a data fetching module, which may retrieve an updated set of industry standard data comprising industry trend data and error type data related to one or more of technology areas, application areas and device categories related to the plurality of entities from a plurality of external data sources. In an instance, the data fetching module may be a web crawler, or a data fetching bot. The plurality of external data sources may include the Internet, a public cloud data service, private cloud data network, proprietary databases and the like. Further the retrieved set of industry standard data may be analyzed and validated by the processing module.

Further, the error type associated with the one or more of the technology areas, the application areas and the device categories may be identified, by the processing module. Further, the validated set of industry standard data, and a set of predefined external rules, maybe stored in an error content database, where a predefined external rule may include one or more service needs mapped to one or more validated industry standard data. Furthermore, via a second communication interface of the digital research expert, one or more predefined external rules, error type data related to the at least one service need, an updated set of technology areas, application areas, and device categories associated with the at least one service need maybe provided to the automated digital service desk, upon receiving a request for the industry standard data related to the at least one service need from the first communication interface of the automated digital service desk.

At 212, the one or more predefined technology area, predefined application area, and device category, associated with the at least one service need may be identified by the automated digital service desk, upon receiving the updated set of technology areas, application areas, and device categories associated with the at least one service need from the digital research expert.

At 214, an error type associated with the at least one service need may be retrieved by the automated digital service desk from the digital research expert.

At 216, a resolution to the error type associated with the at least one service need may be requested by the automated digital service desk to the solution bot.

At 218, if a satisfactory resolution to the at least one service need is retrieved from the solution database by the solution bot, the method flows to step 220. The solution database may typically store a plurality of resolutions provided to a plurality of service needs that occurred before receiving the at least one service need. Hence the satisfactory resolution to the at least one service need may be present in the solution database, if resolution to a service need similar in nature and occurrence to the at least one service is present in the solution database.

At 218, provisioning of the resolution via the solution bot to the entity may be enabled by the automated digital service desk when the solution bot succeeds in retrieving a satisfactory resolution to the at least one service need from the solution database. In case the satisfactory resolution to the at least one service need cannot be retrieved from the solution database, the method flows to step 224.

At 224 a specific service provider organization and a specific resolver group capable of resolving the at least one service need may be identified by the automated digital service desk, when the solution bot fails to retrieve the satisfactory resolution to the at least one service need.

At 226 the at least one service need may be assigned by the automated digital service desk, to the specific resolver group for enabling resolution of the at least one service need by the specific resolver group as per predefined service resolution agreements. For example, the enterprise may execute a plurality of service resolution agreements with a plurality of service provider organizations, for resolving service needs that are unresolved via the solution bot. In an example, a production unit of a manufacturing company may enter into a service resolution agreement with an organization dealing with spare parts and maintenance of a lathe machine used during production within a premises of the manufacturing company.

It may be noted that the above-described examples of the present solution may be for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the procedures of any method or process so disclosed, may be combined in any combination, except combinations where at least some of such features and/or procedures are mutually exclusive.

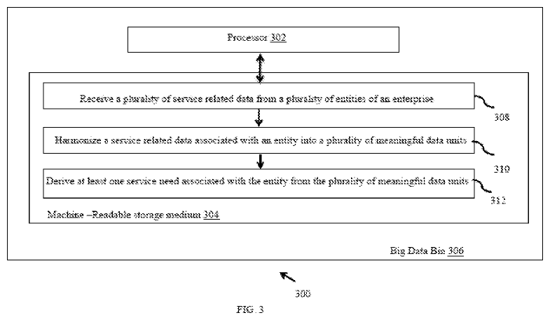

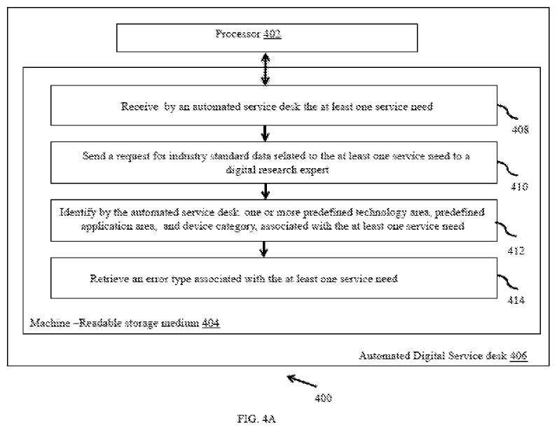

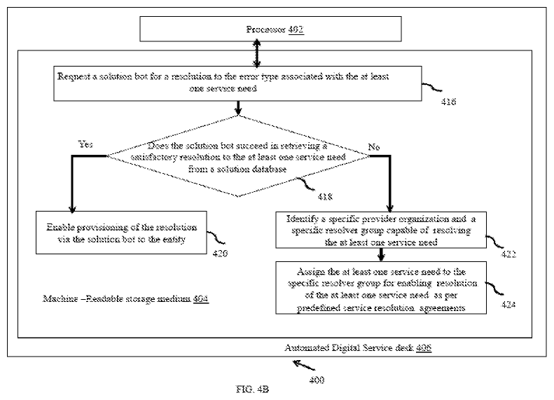

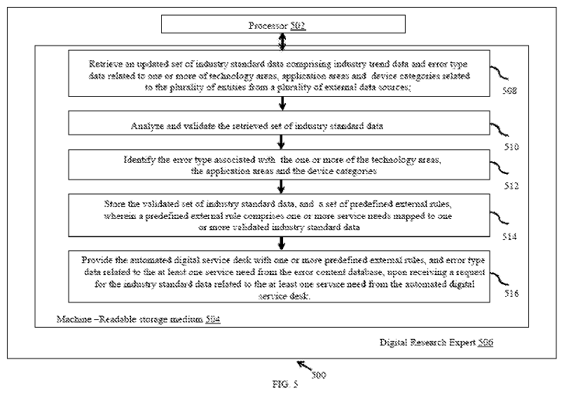

FIGS. 3, 4A-4B and 5 are example block diagrams 300, 400 and 500 showing a non-transitory computer-readable media that stores code for operation in accordance with an example of the techniques of the present disclosure. Particularly FIG. 3 illustrates a big data bin 306 implementation (e.g. 300) of an automation process of retrieving at least one service need associated with an entity of an enterprise from a plurality of service related data. Particularly FIGS. 4A and 3B illustrate an automatic digital service desk 406 including a solution bot implementation (e.g., 400) of an automation process for resolving service needs of an enterprise. FIG. 5 illustrates a digital research expert 506 implementation (e.g., 500) of an automation process for retrieving updated set of industry standard data comprising industry trend data and error type data related to one or more of technology areas, application areas and device categories related to a plurality of entities of the enterprise. Non-transitory computer-readable media includes a machine readable storage medium 304 on the big data bin 306, machine readable storage medium 404 on the automated digital service desk 406, and machine readable storage medium 404 on the digital research expert 406. Non-transitory computer-readable media may be generally referred by the reference numbers 300, 400, and 500 and may be included in a computing system. Non-transitory computer-readable media 304, 404 and 504 may correspond to any storage device that stores computer-implemented instructions, such as programming code and the like. For example, non-transitory computer-readable media 304, 404 and 504 may include non-volatile memory, volatile memory, and/or storage devices. Examples of non-volatile memory include, but are not limited to, electrically erasable programmable Read Only Memory (EEPROM) and Read Only Memory (ROM). Examples of volatile memory include, but are not limited to, Static Random Access Memory (SRAM), and dynamic Random Access Memory (DRAM). Examples of storage devices include, but are not limited to, hard disk drives, compact disc drives, digital versatile disc drives, optical drives, and flash memory devices.

Processors 302, 402 and 502 generally retrieve and execute the instructions stored in a non-transitory computer-readable media 304, 404 and 504, respectively, to operate the present techniques in accordance with an example. In one example, the tangible, computer-readable media 304 and 404 can be accessed by the respective one of processors 302, 402 and 502 over a bus.

Machine-readable storage media 304 may store instructions 308-312. In an example, instructions 308-312 may be executed by processor 302 on the big data bin 306 to provide a mechanism for deriving at least one service need associated with an entity as described in FIG. 2.

Machine-readable storage media 404 may store instructions 408-424. In an example, instructions 408-424 may be executed by processor 402 on the automated digital service desk 406 to provide a mechanism for resolution of service needs to the enterprise as described in FIG. 2.

Machine-readable storage media 504 may store instructions 508-516. In an example, instructions 508-516 may be executed by processor 502 to provide a mechanism for retrieving industry standard related to a plurality of entities in the enterprise of the digital research expert as described in reference with FIG. 2.

As used herein, a “processor” may include processor resources such as at least one of a Central Processing Unit (CPU), a semiconductor-based microprocessor, a Graphics Processing Unit (GPU), a Field-Programmable Gate Array (FPGA) to retrieve and execute instructions, other electronic circuitry suitable for the retrieval and execution instructions stored on a computer-readable medium, or a combination thereof. The processor fetches, decodes, and executes instructions stored on computer-readable medium to perform the functionalities described below. In other examples, the functionalities of any of the instructions of computer-readable media 304, 404 and 504 may be implemented in the form of electronic circuitry, in the form of executable instructions encoded on a computer readable storage medium, or a combination thereof.

As used herein, a “computer-readable medium” may be any electronic, magnetic, optical, or other physical storage apparatus to contain or store information such as executable instructions, data, and the like. For example, any computer-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any computer-readable medium described herein may be non-transitory. In examples described herein, a computer-readable medium or media may be part of an article (or article of manufacture). An article or article of manufacture may refer to any manufactured single component or multiple components. The medium may be located either in the system executing the computer-readable instructions, or remote from but accessible to the system (e.g., via a computer network) for execution. In the example of FIGS. 3, 4A-4B and 5, each of computer-readable media 304, 404 and 504 may be implemented by one computer-readable medium, or multiple computer-readable media.

In examples described herein, devices, such as a plurality of adaptors may communicate with the big data bin via a network interface device. In examples described herein, a “network interface device” may be a hardware device to communicate over at least one computer network. In some examples, a network interface may be a Network Interface Card (NIC) or the like. As used herein, a computer network may include, for example, a Local Area Network (LAN), a Wireless Local Area Network (WLAN), a Virtual Private Network (VPN), the Internet, a public cloud, a private cloud, a hybrid cloud network and the like, or a combination thereof. In some examples, a computer network may include a telephone network (e.g., a cellular telephone network).

In some examples, instructions may be part of an installation package that, when installed, may be executed by processors 302, 402 and 502 to implement the functionalities described herein in relation to instructions. In such examples, computer-readable media 304, 404 and 504 may be a portable medium, such as a CD, DVD, or flash drive, or a memory maintained by a server from which the installation package can be downloaded and installed. In other examples, instructions may be part of an application, applications, or component(s) already installed on the automated digital service desk 306 and the digital research expert 406 including processors 302, 402 and 502, respectively. In such examples, computer-readable media 304, 404 and 504 may include memory such as a hard drive, solid state drive, or the like.

It may be noted that the above-described examples of the present solution may be for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the procedures of any method or process so disclosed, may be combined in any combination, except combinations where at least some of such features and/or procedures are mutually exclusive.

The terms “include,” “have,” and variations thereof, as used herein, have the same meaning as the term “comprise” or appropriate variation thereof. Furthermore, the term “based on,” as used herein, means “based at least in part on.” Thus, a feature that may be described as based on some stimulus can be based on the stimulus or a combination of stimuli including the stimulus.

The present description has been shown and described with reference to the foregoing examples. It may be understood, however, that other forms, details, and examples can be made without departing from the spirit and scope of the present subject matter that is defined in the following claims.

What is claimed is:

1. A system comprising:
a bigdata processing module configured to:
receive a plurality of service related data from a network interface communicatively coupled to a plurality of entities of an enterprise; and
harmonize a service related data associated with an entity into a plurality of meaningful data units based on at least one of entity specific rules, entity related properties, enterprise related policies, and enterprise related procedures;
derive at least one service need associated with the entity from the plurality of meaningful data units based on predefined enterprise rules; and
an automated digital service desk comprising:
a first communication interface configured to:
receive the at least one service need from the bigdata processing module; and
send a request for industry standard data related to the at least one service need to a digital research expert; and
at least one processor configured to:
identify one or more predefined technology area, predefined application area, and device category, associated with the at least one service need upon receiving an updated set of technology areas, application areas, and device categories associated with the at least one service need from a digital research expert; retrieve an error type associated with the at least one service need based on the identified one or more predefined technology area, predefined application area, and device category from the digital research expert request a solution bot for a resolution to the error type associated with at least one service need; enable provisioning of the resolution via the solution bot to the entity when the solution bot succeeds in retrieving a satisfactory resolution to the at least one service need from a solution database; identify a specific service provider organization and a specific resolver group capable of resolving the at least one service need when the solution bot fails to retrieve the satisfactory resolution to the at least one service need; and
assign the at least one service need to the specific resolver group for enabling resolution of the at least one service need by the specific resolver group as per predefined service resolution agreements.

2. The system of claim 1, further comprising:
a plurality of adaptors, each adaptor coupled to an entity of the enterprise, configured to:
fetch the plurality of service related data from the plurality of entities; and
communicate the plurality of service related data to the network interface coupled to the bigdata processing module.

3. The system of claim 1, wherein an entity comprises one of a personnel, a consumer application, a business application, a machine and a device associated with the enterprise.

4. The system of claim 1, further comprising:
a big data storage structure, communicatively coupled to the network interface, configured to store the plurality of service related data in one of a structured, unstructured, and semi-structured format.

5. The system of claim 1, wherein the digital research expert comprises:
a data fetching module, configured to retrieve an updated set of industry standard data comprising industry trend data and error type data related to one or more of technology areas, application areas and device categories related to the plurality of entities from a plurality of external data sources;
a processing module configured to:
analyze, and validate the retrieved set of industry standard data; and
identify the error type associated with the one or more of the technology areas, the application areas and the device categories;
an error content database configured to store:
the validated set of industry standard data, and a set of predefined external rules, wherein a predefined external rule comprises one or more service needs mapped to one or more validated industry standard data; and
a second communication interface configured to provide the automated digital service desk with one or more predefined external rules, and error type data related to the at least one service need from the error content database, upon receiving a request for the industry standard data related to the at least one service need from the first communication interface of the automated digital service desk.

6. The system of claim 1, wherein the at least one processor of the automated Digital Service Desk is further configured to:
update the solution bot and the solution database with the resolution provided by the specific resolver group when the solution bot fails to provide the satisfactory resolution to the at least one service need.

7. The system of claim 1, wherein the service need comprises one of an incident, a problem, a service request, and a change request.

8. The system of claim 7, wherein the at least one processor of the automated digital service desk is further configured to:
identify the at least one service need as the incident when the plurality of meaningful data units map to a first pattern that indicates existence of an abnormality in reference to an expected key performance indicator of the entity;
identify the at least one service need as the problem when the plurality of meaningful data units map to a second pattern that indicates a probability of occurrence of an abnormality in reference to the expected key performance indicator of the entity; identify the at least one service need as the service request when the plurality of meaningful data units map to a third pattern that indicates one of provisioning of resources and execution of additional tasks essential for meeting at least one requirement of the entity; and identify the at least one service need as the change request when the plurality of meaningful data units map to a fourth pattern that indicates enhancing the expected performance behavior of the entity to meet at least one additional enterprise requirements.

9. A computer-implemented method, comprising;
receiving, by a big data bin through a big data processing module, a plurality of service related data from a network interface communicatively coupled to a plurality of entities of an enterprise;
harmonizing, by the big data processing module, a service related data associated with an entity into a plurality of meaningful data units based on at least one of entity specific rules, entity related properties, enterprise related policies, and enterprise related procedures;
deriving, by the big data processing module, at least one service need associated with the entity from the plurality of meaningful data units based on predefined enterprise rules;
receiving, by an automated digital service desk, the at least one service need from the bigdata processing module;
sending, by the automated digital service desk, a request for industry standard data related to the at least one service need to a digital research expert;
identifying, by the automated digital service desk, one or more predefined technology area, predefined application area, and device category, associated with the at least one service need upon receiving an updated set of technology areas, application areas, and device categories associated with the at least one service need from a digital research expert;
retrieving, by the automated digital service desk, an error type associated with the at least one service need based on the identified one or more predefined technology area, predefined application area, and device category from the digital research expert requesting, by the automated digital service desk, a solution bot for a resolution to the error type associated with at least one service need; enabling, by the automated digital service desk, provisioning of the resolution via the solution bot to the entity when the solution bot succeeds in retrieving a satisfactory resolution to the at least one service need from a solution database;
identifying, by the automated digital service desk, a specific service provider organization and a specific resolver group capable of resolving the at least one service need when the solution bot fails to retrieve the satisfactory resolution to the at least one service need; and
assigning, by the automated digital service desk, the at least one service need to the specific resolver group for enabling resolution of the at least one service need by the specific resolver group as per predefined service resolution agreements.

10. The computer-implemented method of claim 9, further comprising:
fetching, by a plurality of adaptors, the plurality of service related data from the plurality of entities, wherein each adaptor coupled to an entity of the enterprise; and
communicating, by the plurality of adaptors, the plurality of service related data to the network interface coupled to the bigdata processing module.

11. The computer-implemented method of claim 9, wherein an entity comprises one of a personnel, a consumer application, a business application, a machine and a device associated with the enterprise.

12. The computer-implemented method of claim 9, further comprising:
storing, by a big data storage structure, the plurality of service related data in one of a structured, unstructured, and semi-structured format, wherein the big data storage structure is communicatively coupled to the network interface.

13. The computer-implemented method of claim 9, wherein the digital research expert comprises:
retrieving, by a data fetching module of the digital research expert, an updated set of industry standard data comprising industry trend data and error type data related to one or more of technology areas, application areas and device categories related to the plurality of entities from a plurality of external data sources;
analyzing and validating, by a processing module of the digital research expert, the retrieved set of industry standard data;
identifying, by the processing module, the error type associated with the one or more of the technology areas, the application areas and the device categories;
storing, by an error content database of the digital research expert, the validated set of industry standard data, and a set of predefined external rules, wherein a predefined external rule comprises one or more service needs mapped to one or more validated industry standard data; and providing, by a second communication interface of the digital research expert, the automated digital service desk with one or more predefined external rules, and error type data related to the at least one service need from the error content database, upon receiving a request for the industry standard data related to the at least one service need from the first communication interface of the automated digital service desk.

14. The computer-implemented method of claim 9, further comprising:
updating, by the automated Digital Service Desk, the solution bot and the solution database with the resolution provided by the resolver group when the solution bot fails to provide the satisfactory resolution to the at least one service need.

15. The computer-implemented method of claim 9, wherein the service need comprises one of an incident, a problem, a service request, and a change request.

16. The computer-implemented method of claim 15, further comprising:
identifying, by the automated Digital Service Desk, the service need as the incident when the plurality of meaningful data units map to a first pattern that indicates existence of an abnormality in reference to an expected key performance indicator of the entity; identifying, by the automated Digital Service Desk, the service need as the problem when the plurality of meaningful data units map to a second pattern that indicates a probability of occurrence of an abnormality in reference to the expected key performance indicator of the entity;
identifying, by the automated Digital Service Desk, the service need as the service request when the plurality of meaningful data units map to a third pattern that indicates one of provisioning of resources and execution of additional tasks essential for meeting at least one requirement of the entity; and
identifying, by the automated Digital Service Desk, the service need as the change request when the plurality of meaningful data units map to a fourth pattern that indicates enhancing the expected performance behavior of the entity to meet at least one additional enterprise requirements.

17. A non-transitory computer readable medium having stored thereon instructions for resolving service needs of an enterprise comprising machine executable code which when executed by at least one processor, causes the processor to perform steps comprising:
receiving, by a big data processing module, a plurality of service related data from a network interface communicatively coupled to a plurality of entities of an enterprise;
harmonizing, by the big data processing module, a service related data associated with an entity into a plurality of meaningful data units based on at least one of entity specific rules, entity related properties, enterprise related policies, and enterprise related procedures;
deriving, by the big data processing module, at least one service need associated with the entity from the plurality of meaningful data units based on predefined enterprise rules;
receiving, by an automated digital service desk, the at least one service need from the bigdata processing module;
sending, by the automated digital service desk, a request for industry standard data related to the at least one service need to a digital research expert;
identifying, by the automated digital service desk, one or more predefined technology area, predefined application area, and device category, associated with the at least one service need upon receiving an updated set of technology areas, application areas, and device categories associated with the at least one service need from a digital research expert;
retrieving, by the automated digital service desk, an error type associated with the at least one service need based on the identified one or more predefined technology area, predefined application area, and device category from the digital research expert;
requesting, by the automated digital service desk, a solution bot for a resolution to the error type associated with at least one service need;
enabling, by the automated digital service desk, provisioning of the resolution via the solution bot to the entity when the solution bot succeeds in retrieving a satisfactory resolution to the at least one service need from a solution database;
identifying, by the automated digital service desk, a specific service provider organization and a specific resolver group capable of resolving the at least one service need when the solution bot fails to retrieve the satisfactory resolution to the at least one service need; and
assigning, by the automated digital service desk, the at least one service need to the specific resolver group for enabling resolution of the at least one service need by the specific resolver group as per predefined service resolution agreements.

18. The non-transitory computer readable medium of claim 17, causes the processor to perform steps, further comprising:
fetching, by a plurality of adaptors, the plurality of service related data from the plurality of entities, wherein each adaptor coupled to an entity of the enterprise; and
communicating, by the plurality of adaptors, the plurality of service related data to the network interface coupled to the bigdata processing module.

19. The non-transitory computer readable medium of claim 17, causes the processor to perform steps, further comprising:
retrieving, by a data fetching module of the digital research expert, an updated set of industry standard data comprising industry trend data and error type data related to one or more of technology areas, application areas and device categories related to the plurality of entities from a plurality of external data sources;
analyzing and validating, by a processing module of the digital research expert, the retrieved set of industry standard data;
identifying, by the processing module, the error type associated with the one or more of the technology areas, the application areas and the device categories;
storing, by an error content database of the digital research expert, the validated set of industry standard data, and a set of predefined external rules, wherein a predefined external rule comprises one or more service needs mapped to one or more validated industry standard data; and
providing, by a second communication interface of the digital research expert, the automated digital service desk with one or more predefined external rules, and error type data related to the at least one service need from the error content database, upon receiving a request for the industry standard data related to the at least one service need from the first communication interface of the automated digital service desk.

20. The non-transitory computer readable medium of claim 17, causes the processor to perform steps, further comprising:
updating, by the automated Digital Service Desk, the solution bot and the solution database with the resolution provided by the resolver group when the solution bot fails to provide the satisfactory resolution to the at least one service need.
